(19) United States
(12) Patent Application Publication
(10) Pub. No.: US 2008/0211431 A1
(43) Pub. Date: Sep. 4, 2008

(54) Pulse-to-Pulse-Switchable Multiple-Energy Linear Accelerators Based on Fast RF Power Switching

(75) Inventors: Andrey V. Mishin, North Andover, MA (US); Aleksandr Y. Saverskiy, North Andover, MA (US)

Correspondence Address: BROMBERG & SUNSTEIN LLP, 125 SUMMER STREET, BOSTON, MA, 02110-1618, US

(73) Assignee: AMERICAN SCIENCE AND ENGINEERING, INC., Billerica, MA (US)

(21) Appl. No.: 12/057,991

(22) Filed: Mar. 28, 2008

Related U.S. Application Data
(63) Continuation-in-part of application No. 11/931,431, filed on Oct. 31, 2007.
Application No. 11/931,431 is a continuation-in-part of application No. 10/957,770, filed on Oct. 4, 2004, now abandoned.
Application No. 10/957,770 is a continuation-in-part of application No. 10/750,178, filed on Dec. 31, 2003.
Application No. 10/750,178 is a continuation-in-part of application No. 09/818,987, filed on Mar. 27, 2001, now abandoned.
Application No. 10/957,770 is a continuation-in-part of application No. 10/156,989, filed on May 29, 2002, now abandoned.
Application No. 10/957,770 is a continuation-in-part of application No. 10/161,037, filed on May 31, 2002, now Pat. No. 7,010,094.
Application No. 10/161,037 is a continuation-in-part of application No. 09/919,352, filed on Jul. 30, 2001, now abandoned.
Application No. 09/919,352 is a continuation-in-part of application No. 09/502,093, filed on Feb. 10, 2000, now Pat. No. 6,459,761.
(60) Provisional application No. 60/192,425, filed on Mar. 28, 2000.
(60) Provisional application No. 60/360,854, filed on Mar. 1, 2002.
(60) Provisional application No. 60/908,735, filed on Mar. 29, 2007.

(51) Int. Cl. H05H 9/00

(52) U.S. Cl. 315/505

(57) ABSTRACT

A method and apparatus for modulating at least one of energy and current of an electron beam in a linac for fast switching of particle beam energy on a time scale comparable with, and shorter than, the interval between linac pulses. Such modulation may be achieved by dividing, in a coupler, a radio-frequency (RF) field into field components and coherently adding these components in a phase shifting section to selectively direct the RF field to a chosen section of the linac. The phase shifting section may include at least one arm containing at least one fast switch and at least one phase changer. In specific embodiments, the phase shifting section may include an electronically controlled plasma switch and a plasma short.

### CROSS-REFERENCE TO RELATED APPLICATIONS

The present application is a continuation-in-part of a U.S. Ser. No. 11/931,431 filed Oct. 31, 2007 as a continuation-in-part of U.S. Ser. No. 10/957,770, now abandoned, which was a continuation-in-part of a U.S. Ser. No. 10/750,178, itself a continuation-in-part application of a U.S. Ser. No. 09/818,987, filed Mar. 27, 2001, claiming priority from U.S. Provisional Application Ser. No. 60/192,425, filed Mar. 28, 2000. One of the antecedent applications to the present application, U.S. Ser. No. 10/957,770, was also a continuation-in-part application of U.S. patent application Ser. No. 10/156,989, filed May 29, 2002, which claims priority from a U.S. Provisional Application with Ser. No. 60/360,854, filed Mar. 1, 2002, as well as a continuation-in-part of U.S. patent application Ser. No. 10/161,037, which is a continuation-in-part of U.S. patent application Ser. No. 09/919,352, filed Jul. 30, 2001 which is a continuation-in-part of U.S. patent application Ser. No. 09/502,093, filed Feb. 10, 2000. Each of the abovementioned applications is incorporated herein by reference in its entirety. This current application claims priority from all of the aforementioned applications.

The present application also claims priority from U.S. Provisional Application Ser. No. 60/908,735, filed Mar. 29, 2007, which is incorporated herein by reference.

### TECHNICAL FIELD

The present invention relates to linear accelerators and to the rapid modulation of a delivered dose of x-rays or charged particles.

### BACKGROUND OF THE INVENTION

X-ray inspection of containers is well established for many purposes including the search for contraband, stolen property and the verification of the contents of shipments that cross national borders. When an object enclosed within a container is detected, various characteristics can be assessed by its interaction with penetrating radiation. If lower energy x-rays (i.e., less than 500 keV) traverse the object, the object can be assumed to not incorporate high-atomic-number fissile materials associated with a nuclear or radioactive device. Observation of backscattered radiation can give more substantive information regarding organic content.

Upon probing of an object opaque to low energy x-rays with high energy x-rays (i.e., in a range up to approximately 3.5 MeV), regions of dense material are both more readily penetrated and more readily traversed. Regions opaque to high energy x-rays may be unusually dense fissile material. However, a container of dense material may still shield the characteristic x-rays emitted by such material from detection. Ability to optimize the energy of the emitted photon (when a bremsstrahlung conversion target is installed at the output end of the linear accelerator beam line to generate x-rays) is, therefore, advantageous.

As known in the art, changing the energy of the accelerated particle beam can be achieved by changing the power from a radio frequency (“RF”, used herein interchangeably with “microwave”) power source directed to an accelerator section or sections. However, since the RF power source must operate at precise power, frequency and phase needed to accelerate the particles to obtain maximum power output, changing the power of the source to assure the formation and maintenance of particle bunches and avoid the destruction of the particle beam during the acceleration process is not a trivial task. Satisfying these concerns, in turn, requires a judicious design of accelerator sections in order to maintain the particle beam dynamics in these accelerator sections at different power levels and to meet specification parameters of the beam (such as spectrum or electron beam efficiency, for example).

Several different techniques have been described in the literature for “slow” switching of the particle beam energy. As used herein, the term “slow”, applied to particle beam switching, refers to switching on a time scale which is long in comparison to the interval between the accelerator beam pulses. Such interval is typically on the order of several milliseconds or more. In comparison, the term “fast” describes switching on the time scale comparable with and shorter than the interval between the pulses in a typical linac. High-power particle acceleration systems using a klystron as an RF power source are known to allow for convenient fast modulation of both power and frequency of the power source using a driving RF generator. For magnetron-driven systems, however, switching of power by means of varying the magnetron power is not straightforward. One of the known methods for “slow” switching particle beam energy (useful, for example, for an occasional adjustment in a linac driven by a magnetron) is varying the power of the magnetron through varying its anode current. Various patents relate to power control of accelerators including U.S. Pat. Nos. 5,661,377, 6,824,653, 6,844,689, 7,110,500, and 7,112,924, as does pending US patent application 2005/0117683, each of which is incorporated herein by reference in its entirety.

### SUMMARY OF THE INVENTION

Embodiments of the invention provide a method for modulating at least one of energy and current of an electron beam in a linear accelerator that is powered by a radio frequency (RF) source generating an RF field. In one embodiment, the RF source may be a magnetron. The method comprises coupling the RF power into an accelerator section followed by modulating the RF power by post-generation modulation of the RF field. Such post-generation modulation may include selective direction of the RF field on the basis of the phase of the RF field. To achieve such selective direction, in some embodiments the RF field may be divided into components, for example with a hybrid coupler, followed by coherently adding those field components to one another. In addition, the method may comprise applying constant RF power to another accelerator section coupled with the accelerator section in series or in parallel and applying modulated RF power to another accelerator section. In alternative embodiments of the invention, the modulation of RF power may be achieved by switching the RF power on and off. In specific embodiments of the invention, the modulation of the at least one of energy and current of the electron beam may include the modulation at a rate from about 25 to 1,000 pulses per second.

Additional embodiments of the invention provide a switch system for modulation of at least one of energy and current of an electron beam in a linear accelerator that is powered by a radio frequency (RF) source generating an RF field characterized by a phase, wherein the switch system may comprise an hybrid coupler for dividing the generated RF field into components and an RF phase-shifting section for receiving the components of the RF field. The RF phase-shifting section may be configured to redirect the field components to the hybrid coupler or another hybrid coupler of the switch system to have the field components coherently added. Such RF phase-shifting section may include at least one arm having one or more fast switches and one or more phase changers, wherein the fast switches and the phase changers may be disposed in a corresponding arm in a mutually variable relationship. In specific embodiments the phase changer may include a plasma short and the fast switch may include an electronically controlled plasma switch. The modulation of at least one of energy and current of the electron beam in a linear accelerator with some embodiments of the switch system of the invention may be provided at a rate from about 25 to about 1,000 pulses per second.

Further embodiments of the invention provide a linear accelerator that comprises at least one accelerator section and a switch system for modulation of at least one of energy and current of an electron beam in a linear accelerator. In such embodiments, the switch system may include an hybrid coupler for dividing the generated RF field into components and an RF phase-shifting section comprising at least one arm having at least one fast switch and at least one phase changer that are disposed in mutually variable relationship. Such phase-shifting section may be used to receive the RF field components from the hybrid coupler and coherently add these RF field components. As a result, in some embodiments, the modulation of at least one of energy and current of the electron beam in a linear accelerator includes the modulation at a rate from about 25 to about 1,000 pulses per second.

Furthermore, alternative embodiments provide an inspection system for inspecting an object using penetrating radiation for irradiating the object, the inspection system comprising a linear accelerator of the embodiments described above.

As used herein, the terms “modulate” and “modulation” are used in a broad sense and include varying the amplitude or phase of a signal. The terms “switch” and “switching” are to be taken as particular cases of “modulate” and “modulation” and to include turning a signal on and off, or directing it in whole or in part. “Switching” may be used to implement a more general “modulation.”

### BRIEF DESCRIPTION OF THE DRAWINGS

The features of the invention will be more readily understood by reference to the following detailed description taken with the accompanying drawings:

FIG. 1 is a schematic drawing of low-energy, high-energy, and photo-nuclear-reaction initiating spectra.

FIG. 2 is a schematic diagram of a multiple energy inspection system where a single linear accelerator generates the low-energy, high-energy, and photonuclear-reaction initiating spectra.

FIG. 3 is a schematic diagram of a multiple energy inspection system where a single linear accelerator generates the high-energy and the reaction-initiating spectra and a low-energy x-ray source generates the low-energy spectrum.

FIG. 4 is a schematic diagram of a multiple energy inspection system where two linear accelerators powered from the same source generate the high-energy and reaction-initiating spectra respectively and a low-energy x-ray source generates the low-energy spectrum.

FIG. 5 is a schematic diagram of a multiple energy inspection system where two separately powered linear accelerators generate the high-energy and reaction-initiating spectra respectively and a low-energy x-ray source generates the low-energy spectrum.

FIG. 6 is a schematic depiction of a two-section accelerator that is fed through a directional coupler and switched in accordance with an embodiment of the present invention;

FIG. 7 represents an alternative embodiment of a two-section fast switchable accelerator;

FIG. 8 represents a two-section accelerator with two sets of fast switches that together produce a three-energy beam in fast (pulse-to-pulse) mode, in accordance with another embodiment of the present invention;

FIG. 9 depicts a single-section accelerator powered through a directional coupler having an adjustable coupling coefficient, in accordance with an alternative embodiment of the present invention;

FIG. 10 depicts a triple energy single-section accelerator, in accordance with an embodiment of the present invention;

FIG. 11 shows an embodiment of a single-section accelerator with an active fast switch and permanent short that permit redirecting an RF wave to the accelerator section at a selected power level; and

FIG. 12 depicts a triple-energy embodiment of the single-section accelerator shown in FIG. 11, according to yet another embodiment of the present invention.

### DETAILED DESCRIPTION OF PREFERRED EMBODIMENTS

As known in the art, the spectra of x-rays generated by accelerating electrons into a target, as provided by individual or multiple linear accelerators (“linacs”), may be tailored to cover distinct energy ranges. Use of such distinct spectra, as produced by a linac having a Shaped Energy™ option (see U.S. Pat. No. 6,459,761, “Spectrally Shaped X-Ray Inspection System,” hereby incorporated by reference) may allow for material identification within dense cargo while holding leakage dose rates to cabinet level specifications. A security system may also include backscatter recognition capability for organic recognition, as described, for example, in U.S. Pat. No. 5,313,511.

A dense enclosure (made of lead or tungsten, for example) of fissile material may reduce the flux of characteristic x-rays, or “isotope signatures,” from the isotopes commonly used for detection of nuclear weapons (such as ²³⁵U, ²³⁹Pu, ²³⁸U, ²³²U, or ²⁴¹Pu). For these listed isotopes, one expects to detect 186.7 keV and 205.3 keV, 375 keV and 413.7 keV, 1,001 keV, or 662.4 keV and 722.5 keV x-rays. (See, e.g., copending U.S. Ser. No. 10/750,178). To facilitate reliable recognition of a concealed fissile material one may employ neutron detectors in conjunction with a linac's operational energy range above a threshold of 7-10 MeV to assure generating sufficient photo-neutron flux. An indication of the presence of fissile material may be unusually dense matter in cargo, which cannot be easily or at all penetrated by x-rays at lower energy. An object in cargo may be considered to be composed of unusually dense matter if the object cannot be penetrated by a high-energy x-ray beam, which for example, is generated by an electron beam with energy of 3.5 MeV. (A 3.5 MeV linac provides penetration of up to 300 mm of steel equivalent.) To reduce stray dose delivered to surrounding objects and personnel, the higher energy mode may be run with an extremely short duty cycle, corresponding in some cases to a single pulse or to a few pulses. Such an exposure would be sufficient to detect photo-neutrons while providing an average dose acceptable for a cabinet level system. Typical duration of the pulses may be from tens of nanosecond to microseconds.

Various embodiments of the present invention combine inspection by x-ray transmission with an optional high-energy operation to initiate photon-nucleus reactions in fissile material, if present.

Embodiments of the invention allow an inspection system to rapidly switch operation of a linac, upon observation of unusually dense matter not specified in a cargo manifest, from delivering a low-energy output electron beam to delivering a high-energy electron beam to generate photoneutrons (typically, several MeV) at the target that, in turn, may initiate reactions in fissile material. Alternatively, embodiments of the invention may allow a linac to operate in a regime of alternating a generation of an output electron beam at a first level of energy with that at a second level of energy. Both the switching and alternation of operational regimes may be carried out at rates from about 25 to about 1,000 pulses per second.

This invention takes advantage of the fact that the spectra of x-rays generated by accelerating electrons into a target, as provided by a single- or multiple-section linear accelerator, may be tailored to cover distinct energy ranges. Such tailoring utilizes the fact that RF power driving sections of a typical linac may be judiciously and quickly controlled by varying the parameters of corresponding driving RF field using RF field interference effects that do not require a conventionally used modulation of the RF power source. To this end, to address a problem of “fast” switching a RF-source-driven linear accelerator, embodiments of the invention provide a coupling unit comprising at least one power splitter (or divider) and at least one phase-shifting section for receiving the generated RF field from the RF source and modulating the received RF field. The embodiments of power splitters such as, for example, hybrid RF couplers, may divide the received RF field into field components and direct such components to the phase-shifting section that contains at least one arm. As used herein, the terms “power splitter” and “hybrid coupler” are used in a broad sense and incorporates power dividers and directional couplers that may be characterized by various coupling factors, losses, isolation, and directivity and may be implemented in a variety of construction techniques known in the art. In addition, power splitters may further propagate RF towards and couple it into accelerator sections. The embodiments of phase-shifting section of the invention generally vary the phase of at least one of the RF-field components, which are further coherently added and propagated towards at least one accelerator section. Consequently, the phase-shifting section facilitates modulation of RF power that is further selectively coupled to the at least one accelerator section through the embodiments of the power splitters. Additionally, the phase-shifting section allows for variation in the phase ratio for the propagating and reflected RF waves. Generally, the portion of RF field reflected by the coupling unit may be absorbed in dummy loads. As used herein and in any appended claims, the term “post-generation modulation” means modulation of an output that has already been generated and that exists as RF power somewhere within the system.

Embodiments of the method of the invention are equally applicable to linear accelerators comprising a single section and those comprising a plurality of sections disposed in series or in parallel. Embodiments of a system of the invention, that modulate the phase of the RF field in a phase-shifting section according to the method of the invention on a time scale comparable with the time separating accelerator beam pulses (for pulse-driven accelerators), are characterized by the recovery time comparable to a period between pulses that is typically on the order of several milliseconds. Consequently, the RF power delivered to accelerator sections and, therefore, the particle beam energy at the output of the accelerator may be modulated at a corresponding rate. Embodiments of the invention may utilize various methods of post-generation modulation of phases of the RF field components ranging from use of mechanical devices such as a fast-rotating wheel that varies a reflection coefficient and voltage standing wave ratio (VSWR) to creating a fast plasma “short” in at least one of the arms of a two-arm system. It will be appreciated that some exemplary embodiments, although described below in terms of fast plasma “short”, are not limited with respect to ways the change of phase of an RF field may be implemented and encompass all techniques known or later developed in the art.

A switching device according to embodiments of the invention may be used with any standard accelerator. Energy of the electron beam generated by the described embodiments is defined by selectively directing the generated RF field to the accelerator sections based on coherent addition of phases of the RF field. The power supply for the switching device can be synchronized with the operation of the linac by using the same trigger pulses used for driving the modulator of the linear accelerator. Embodiments of the present invention may be used advantageously in many different fields such as security (for material recognition while scanning dense objects with beams with different bremsstrahlung spectra, for example), or for spectrally shaping irradiation fields for radiation treatment of cancer, etc.

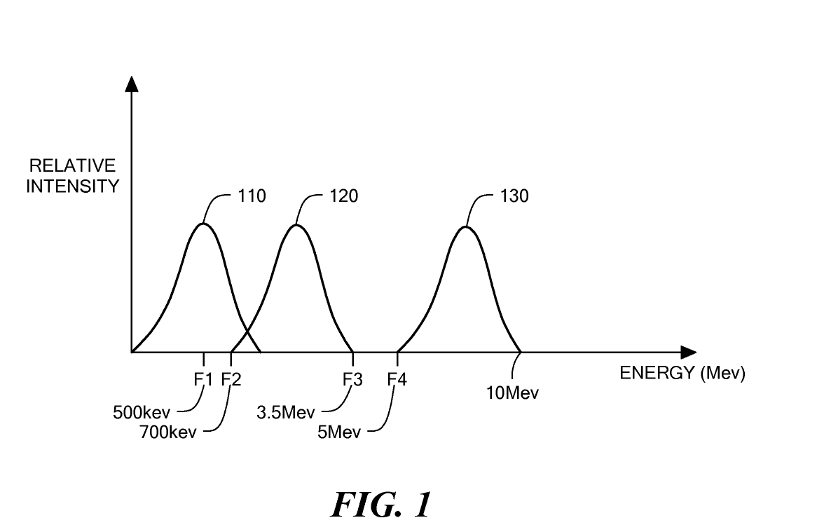

FIG. 1 illustrates three spectra employed in distinguishing an object composed of fissile material. Low-energy spectrum 110 is characterized as dominated by x-ray energies less than or equal to a first fiducial energy F1. That is, half of the x-rays in spectrum 110 have energies less than F1. High-energy spectrum 120 is characterized as dominated by x-rays with energies above second fiducial energy F2 and less than third fiducial energy F3. Photon-nucleus reaction-initiating (i.e., photoneutron-generating) spectrum 130 is characterized as dominated by x-rays with energies above fourth fiducial energy F4, which may be referred to as a photo-nuclear reaction threshold. Each of the low-energy, high-energy, and photon-nucleus reaction-initiating spectrum is further characterized by an intensity.

There are a number of ways to produce the three spectra. For example, the low-energy spectrum 110 may be generated by a standard x-ray tube or as part of a Shaped Energy™ system (available from American Science & Engineering, Inc., Billerica, Mass.) that also generates the high-energy spectrum 120 as a filtered output. A linac may also generate the photoneutron-generating spectrum 130, either as part of a Shaped Energy™ system or individually.

The following provides a detailed description of embodiments of the current invention, illustrated with figures where like elements are labeled with like numbers.

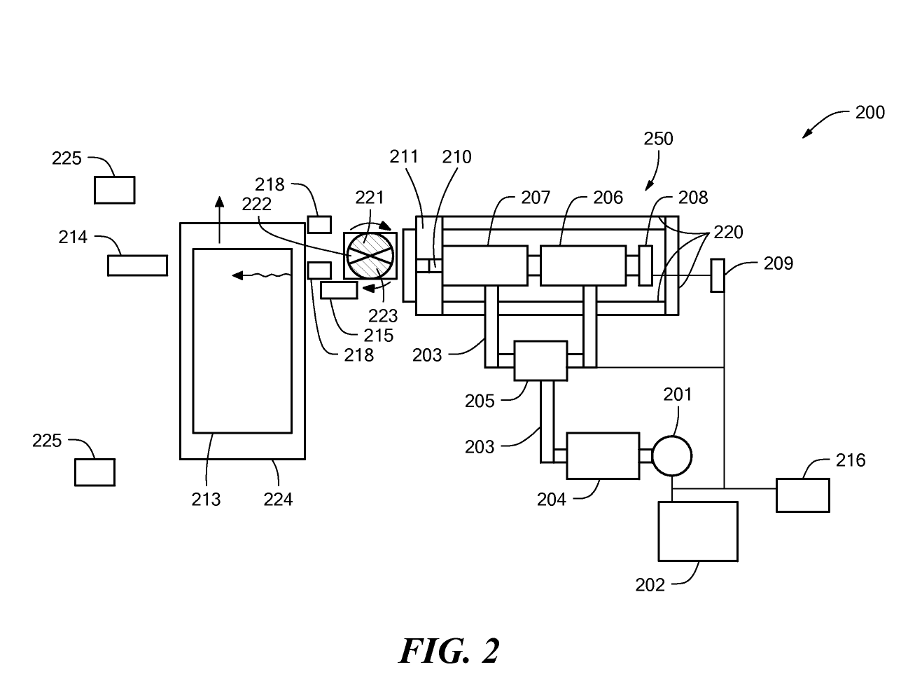

FIG. 2 illustrates an embodiment of an inspection system 200 employing a single linac 250 to generate three spectra—low-energy, high-energy, and photoneutron-initiating. Linac 250 includes a mid-energy section 206 and a high-energy section 207 in tandem. The sections are powered by microwave energy that is generated by microwave power source 201 and that passes through circulator 204 and waveguide 203 before being directed to either or both sections by regulated power divider/phase shifter 205. Electrons generated by electron gun 208 powered by high voltage power supply 209 are accelerated by passage through the mid- and high-energy sections (206 and 207) and generate x-rays in striking heavy metal target 210. The x-rays are collimated by collimator 211 before exiting linac 250.

To produce x-rays corresponding to low-energy and high-energy spectra, only mid-energy section 206 is powered. Collimated x-rays leaving linac 250 pass through absorber 221. If the x-rays pass through open pie pair 222, a low-energy dominated spectrum results. If the x-rays pass through absorbing pie pair 223, a high-energy dominated spectrum results. Low- and/or high-energy x-rays passing through object 213, itself transported on carrier 224 in a direction perpendicular to the path of the x-rays, may be detected by linear detector array 214. Backscattered low-energy x-rays may be detected by backscatter detectors 218.

To produce high-energy x-rays suitable for generating photoneutrons, a regulator or controller 216 directs regulated power divider/phase shifter 205 to energize both mid-energy section 206 and high-energy section 207. At the same time, the console 216 causes the modulator 202 to modulate the microwave power source 201 and the high voltage power supply 209 to generate pulses of photoneutron-generating x-rays. Upon passage through the absorbing pie-shaped region 223 of the absorber 221, the x-rays impinge upon the object 213. Should the object 213 contain fissile material, neutron detector 215 detects photoneutrons generated by reactions within the fissile material initiated by the photoneutron-generating x-rays.

The object 213 is initially exposed to the low-energy x-ray spectrum 110 (for example, dominated by energies less than 500 keV). If the low-energy x-rays penetrate the object 213, backscatter detector 218 may identify organic content in the object 213. If the object 213 is opaque to low-energy x-rays, object 213 may next be exposed to the high-energy x-ray spectrum 120 (for example, dominated by energies greater than 700 keV and less than 3.5 MeV). If the object is opaque to high-energy x-rays, the object may be further exposed to a single pulse or to a few pulses of approximately tens of nanoseconds to microseconds duration of photoneutron-generating spectrum 130 (for example, dominated by energies greater than 5 MeV and less than 10 MeV). The neutron products from the pulse or pulses of radiation may be detected by neutron detector 215, which may be coextensive with a detector of transmitted or scattered x-rays. It is to be understood that detection of other products of the interaction of penetrating radiation with the object are within the scope of this invention.

Use of the linac 250 to generate three spectra of x-rays permits identification of fissile material without system shielding in addition to the shielding 220 immediately surrounding the linac 250. Ambient radiation measured by ambient radiation detectors 225 is held below cabinet levels by a combination of employing a spectra containing higher energy x-rays only when observations based on a lower energy spectra are inconclusive—for example, if the object 213 is not totally penetrated by low-energy x-rays or, subsequently, if the object 213 is not totally penetrated by high-energy x-rays. Even beyond restricting photoneutron-generating x-rays to the latter case, exposure is further restricted by using only one or a couple of pulses to identify fissile material.

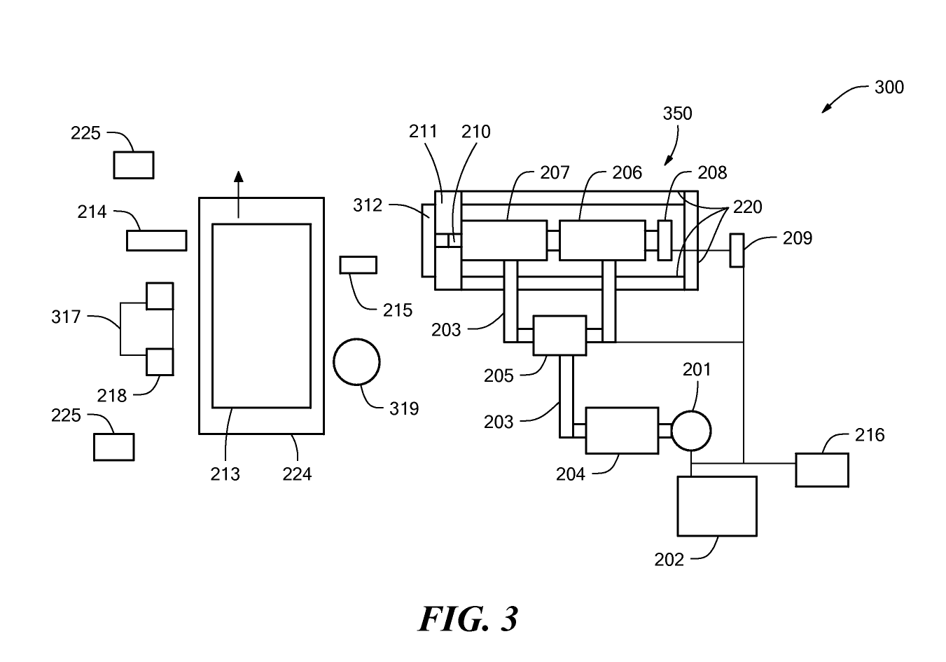

FIG. 3 shows a second inspection system 300 where a low-energy spectrum is furnished by a low-energy x-ray source 317. Low-energy transmission through the object 213 may be detected by a transmission detector 319. Further, backscattered low-energy x-rays may be detected by backscatter detectors 218.

Linac 350 generates high-energy x-rays of spectrum 120 and photoneutron-generating x-rays of spectrum 130 shown in FIG. 1. Low-energy x-rays are absorbed by low energy x-ray absorber 312. Switching between the high-energy spectrum and the photoneutron-generating spectrum is accomplished in the manner described with reference to the inspection system of FIG. 2.

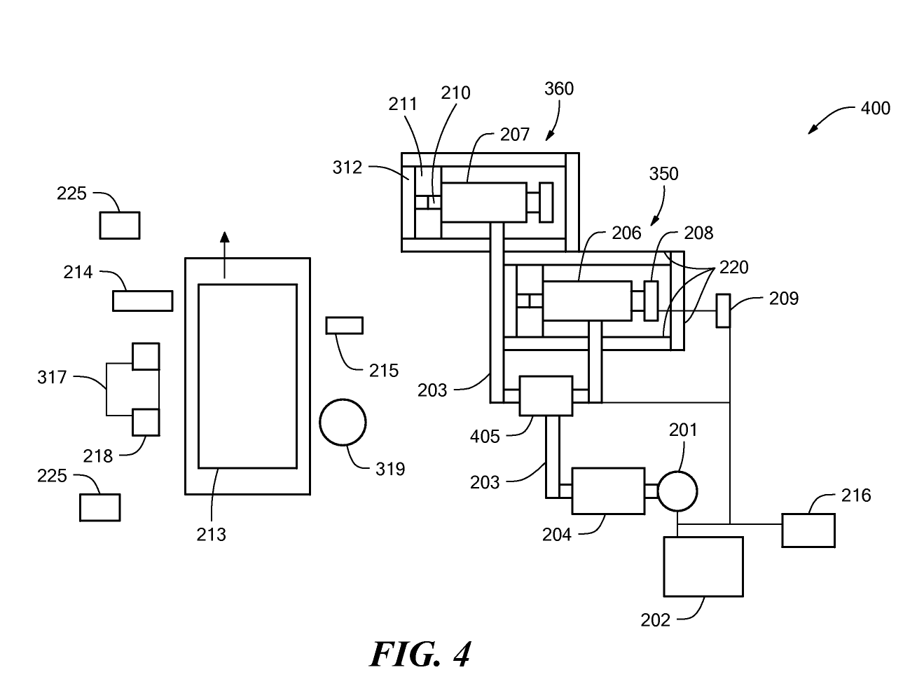

FIG. 4 shows a third inspection system 400 containing separate generators of low-energy, high-energy, and photoneutron-generating x-rays. Low-energy x-rays are generated by low-energy source 317 and detected by low-energy transmission detector 319 and backscatter detector 218. High-energy x-rays are generated by mid-energy section 206 and transmission of high-energy x-rays through object 213 detected by linear detector array 214. Photoneutron-generating x-rays are generated by high-energy section 207. In this embodiment, a fast radio frequency switch 405 selectively directs power from microwave source 201 either to the mid-energy section 206 or to the high-energy (i.e., photoneutron-generating) x-ray section 207. Whereas in inspection system 300, mid-energy and high-energy sections share electron gun 208, microwave power supply 201, collimator 211, and low-energy absorber 312, in inspection system 400, the mid- and high-energy sections have individual electron guns and low-energy absorbers and share microwave power supply 201 and collimator 211. Linear detection array 214 detects high-energy x-ray transmission and photoneutron detector 215 detects photoneutrons.

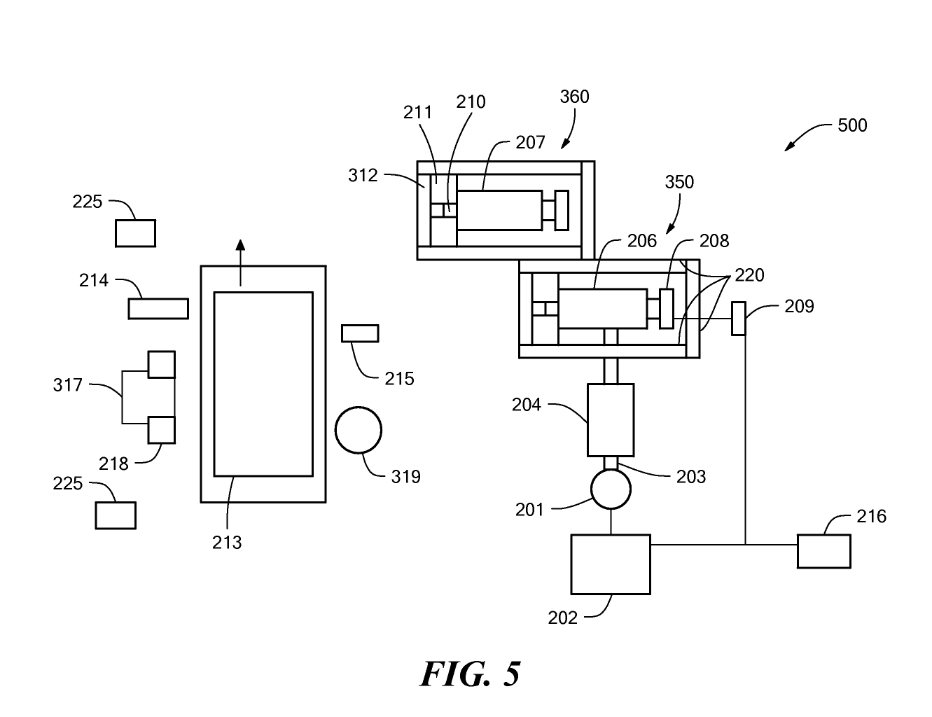

FIG. 5 shows an inspection system 500 where generators of low-energy, high-energy, and photoneutron-generating x-rays are independent of each other. Low-energy x-rays are generated by 317 and detected by detectors 319 and 218 as described for FIGS. 3 and 4. High-energy x-rays are generated by a mid-energy section linac 350 and photoneutron-generating x-rays by an independent high-energy section linac 360. Photoneutron-generating x-rays may be generated for short periods of time as a single pulse or as a series of single pulses while high-energy x-rays and low-energy x-rays are continuously generated.

The following describes embodiments of switching systems of the inventions that may be used in various linacs and linac-based x-ray inspection systems.

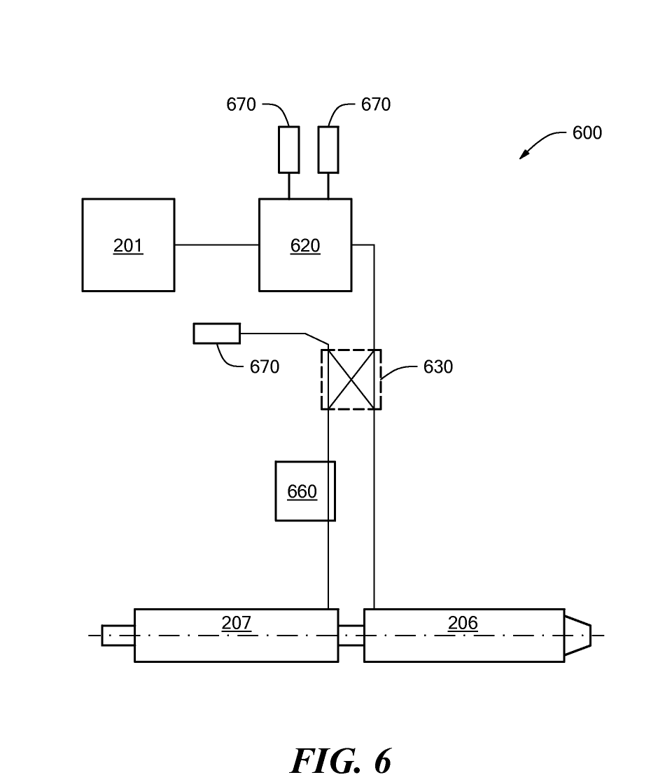

FIGS. 6, 7, and 8 illustrate exemplary fast switching systems that can be utilized with two-section accelerators (such as those described in reference to FIGS. 2, 3 and 4) FIG. 6 schematically illustrates an embodiment 600 of a two-section system driven with power from a microwave generator 201 through an isolator 620 and a directional coupler 630, which generally splits the input power to deliver it to both accelerator sections 206 and 207. As shown in FIG. 6, the sections 206 and 207 are disposed in series. The feed line of the section 206 may contain a fast switching element 660 such as a plasma switch the operation of which causes variation in impedance values and amounts of RF reflected by the switch and, therefore, transmitted through the feedline towards the accelerator section. To this end, in one operational state, the electronically-regulated plasma switch 660 practically does not attenuate power delivered to the section, and the embodiment 600 works as a conventional two-section accelerator system producing an electron beam with high-level energy W_{H}. In a different operational state, the switch reflects the input RF-power reducing, therefore, the accelerating RF-power supplied to the section 206 to a low level nearing zero. In this state, the embodiment 600 generates an electron beam with low energy W_{L}. The RF power reflected by the switch 660 is dissipated in “dummy” loads 670, which may be water or air-cooled.

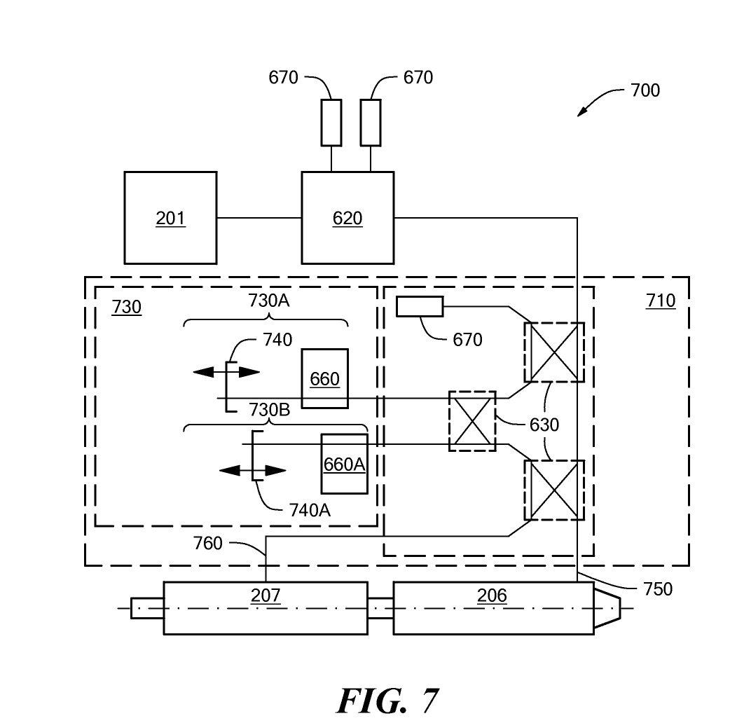

FIG. 7 demonstrates another embodiment 700 of an accelerator with two sections in series. The embodiment 700 comprises a coupling unit 710 having an adjustable coupling coefficient. As shown, the coupling unit may include three quadrature 3-dB directional couplers 630 with the associated dummy load 670, and a phase-shifting section 730. It would be recognized, however, that directional couplers with other splitting ratios may be used if required. Alternatively or in addition, hybrid couplers having the two outputs of equal amplitude but with various phase difference may be used instead of quadrature 3 dB directional couplers. As shown in FIG. 7, the phase-shifting section 730 comprises two equivalent arms 730A and 730B, each of which includes an electronically regulated plasma switch (660 or 660A) and a correspondingly associated phase changer such as moveable plasma short (740 or 740A) and defines the amplitude and phase of an RF field transmitted to the accelerator sections 206 and 207 through the respective output arms 750 and 760. As shown in FIG. 7, the RF phase-shifting section 730 is configured to redirect the field components to back the hybrid coupler 630 for coherent addition of the field components. In alternative embodiments a phase-shifting section may comprise a different number of arms, for example one arm. A term “plasma short” is used in broad sense to include operation of a spark and other discharges, as understood in the art. As a result, the embodiment 700 may generate an electron beam in a high-level energy W_{H} regime when both switches 660 and 660A are active (i.e., turned “on”), and an electron beam with low energy W_{L} when both switches are inactive (or “off”). It should be appreciated that in the current embodiment a precise value of W_{L} is not fixed and can be varied by varying the phase of RF field in the arms of the phase-shifting section depending on the positions of the phase changers 740 and 740A with respect to the corresponding switches. Consequently, the RF power coupled into section 206 is modulated. The RF-energy reflected by the group 730, when the switches prevent the RF field from propagating towards the accelerator sections, is dissipated in one or more dummy loads 670.

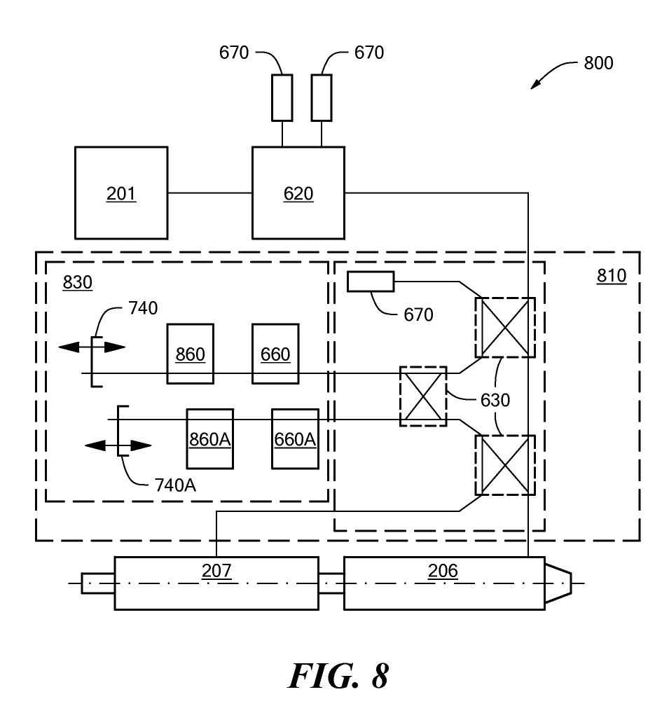

FIG. 8 shows another embodiment 800 performing in a fashion similar to that of the embodiment 700 of FIG. 7 that produces energy beams in fast (pulse-to-pulse) mode at three levels of energy. Here, the embodiment of a coupling unit 810 contains two pairs of fast switches (660, 660A and 860, 860A) disposed respectively in two arms of a phase-shifting section 830 together with corresponding phase changers (such as moveable plasma shorts) 740 and 740A. It should be appreciated that the front switches 660 and 660A, when activated, operate to allow for high energy W_{H} output from the accelerator. A combination of inactive (“off”) switches 660 and 660A and activated (“on”) switches 860 and 860A results in generation of the beam with fixed level of energy W_{L1}<W_{H}. Furthermore, it should be appreciated that one can generate an electron beam having energy that can be modulated. For example, variable energy W_{L2} that is smaller than W_{L1} can be produced when both pairs of plasma switches are inactive by varying relative phases of RF field in arms of the phase-shifting section 830 through changing positions of the moveable shorts 740 and 740A with respect to the switches 860 and 860A.

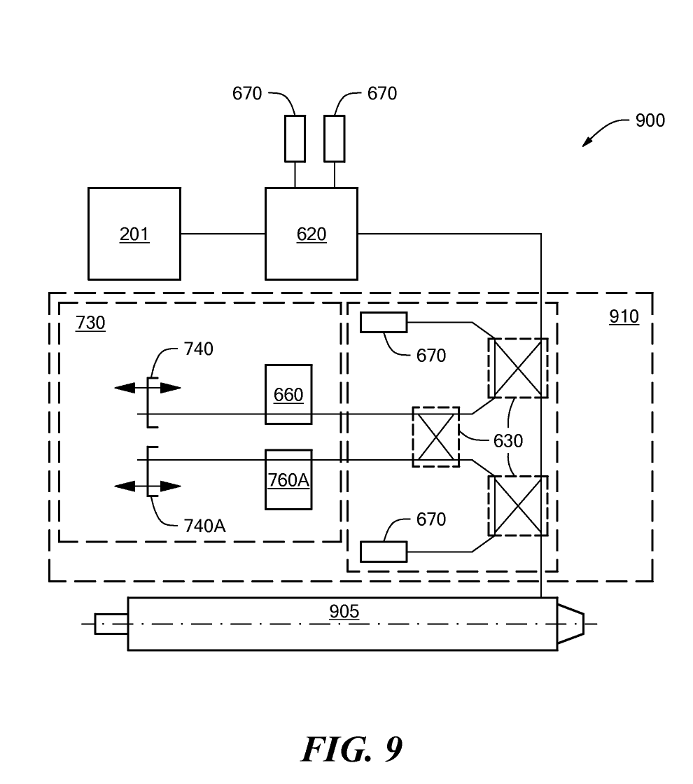

The following FIGS. 9 through 12 refer, generally, to exemplary embodiments of fast switching single-section accelerator systems. FIG. 9 represents an embodiment 900 of an accelerator comprising a single section 905 powered through a coupling unit 910 having an adjustable coupling coefficient. Operation of the embodiment is similar to that discussed in reference to FIG. 7. For example, activation of both switches 660 and 660A of the phase-shifting section 730 permits transmitting maximum feeding power to the accelerator section 905 and results in maximum beam energy W_{H}. Alternatively, the combination of de-activated switches and variable positioning of shorts 740 and 740A permits operation at variable low energy levels W_{L}.

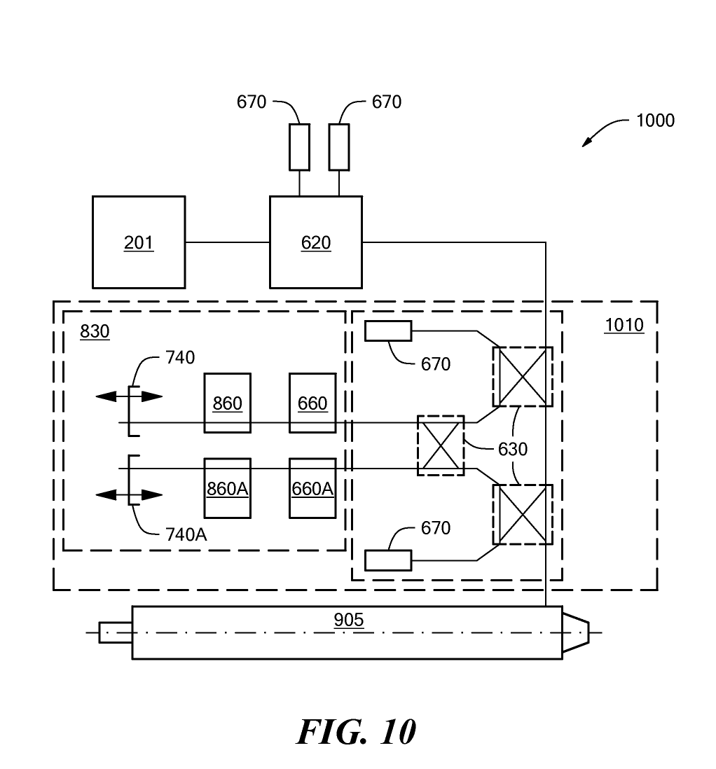

FIG. 10 depicts a single-section embodiment 1000 capable of generating an electron beam at three energy levels. It should be appreciated that various combinations of different switching states (active or inactive) of the two pairs of switches 660,660A and 860,860A and the pair of shorts 740,740A in the phase-shifting section 830 of a coupling unit 1010 may result in different levels of RF-power directed to the accelerator section 905. The different levels of feeding RF-power will correspondingly assure the production of an electron beam at two distinct energy levels W_{H}, W_{L1}<W_{H}, and a variable energy level W_{L2}<W_{L1} in a fashion similar to that discussed in reference to FIG. 8.

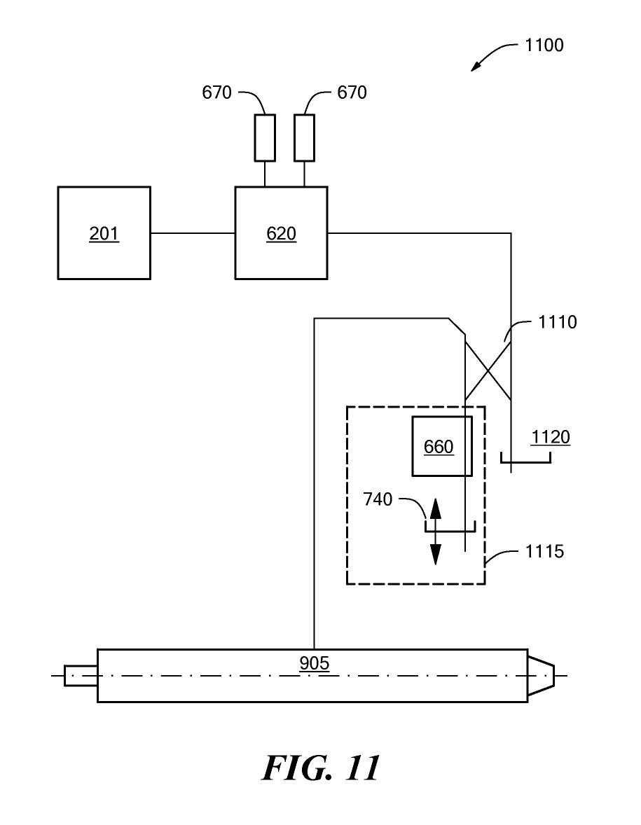

FIG. 11 schematically depicts an alternative embodiment 1100 of a single-section accelerator powered through a single 3-dB hybrid coupler 1110, although other types of couplers may be utilized as required. As shown in the FIG. 11, the phase-shifting section comprises a single arm 1115 that includes the fast switch 660 and the moveable phase-changer 740. The combination of the active fast switch 660 and permanent, fixed short 1120 permit redirecting the RF wave at a maximum power to the accelerator section 905 to produce an output beam at maximum energy W_{H}. When the switch 660 is inactive, however, the variable output beam energy level W_{L} may be determined by the position of the moveable phase-changer 740 with respect to the fast switch 660 of the arm 1115.

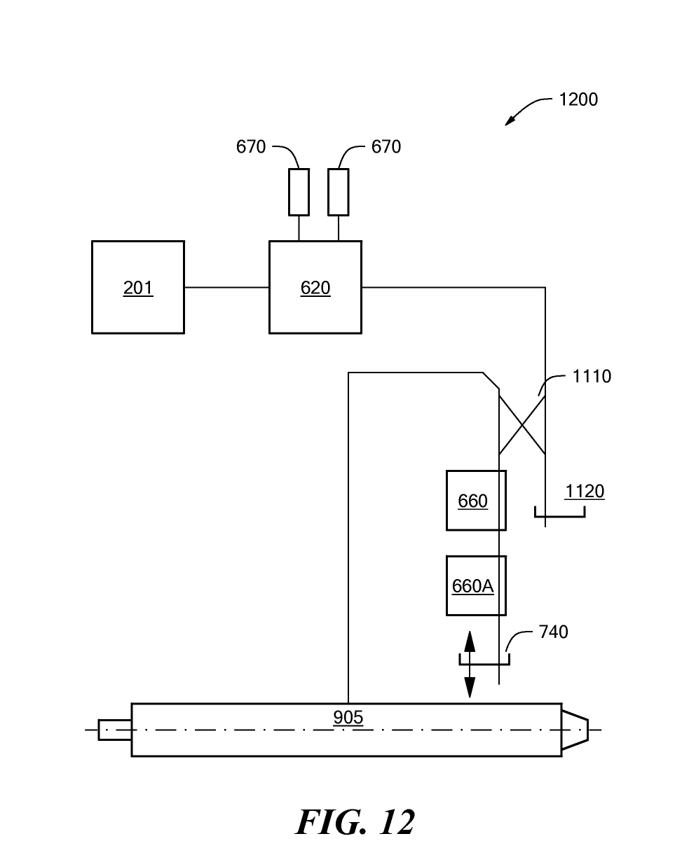

FIG. 12 shows a multi-energy version of the embodiment described in reference to FIG. 11. Here, the active switches 660 and 660A and the short 740, which may be either permanent or moveable, comprise a single-arm phase-shifting section and permit directing variable microwave power to the accelerator section 905. The accelerator section 905 generates, in various pulsed regimes, the output beam having variable energy in a manner similar to that discussed in reference to FIG. 8, for example.

The described embodiments of the invention are intended to be merely exemplary and numerous variations and modifications will be apparent to those skilled in the art. All such variations and modifications are intended to be within the scope of the present invention as defined in the appended claims. For example, in alternative embodiments of the invention, versions of linacs depicted in FIGS. 6 through 12 may be congregated in various combinations to result in accelerator systems with multiple sections arranged in series and/or in parallel and with multiple directional couplers, providing a required distribution of microwave power to each available section, and multiple fast switches that permit generation of an output electron beam having required pulse-to-pulse distribution of energy. For example, to achieve fast switching of energy of the electron beam produced by the linac having at least two accelerating sections in parallel, the RF field powering the first of the at least two parallel sections may be kept on at a constant level while the RF field powering the second of the at least tow parallel sections may be switched on and off according to the above described embodiment of the method of the invention that employs selective direction of the RF field based on coherent addition of phases of the RF field.

In specific embodiments, a real-time adjustment of the output energy level of the electron beam and, therefore, of x-rays generated with such an electron beam may be provided based, for example, upon a measurement of the electron beams' energy during the operation or performed in real time. In addition, a hybrid coupler component, in which the two outputs are of equal amplitude, with various phase difference in the outputs may be used as an element in coupling units of the invention instead of a quadrature 3 dB directional coupler. Also, it would be understood by a skilled artisan that embodiments of the invention can generate output energies in various pulsed regimes characterized by multi-pulse sequences of various lengths and frequencies.

Discussed features and embodiments of the present invention may advantageously provide faster switching of the energy output of a particle accelerator at a reduced cost, increase its reliability and facilitate technical maintenance. Moreover, in accordance with the present invention, a single-energy particle accelerator, such as a linac, may advantageously be transformed readily into a dual energy linac.

We claim:

1. A method for modulating at least one of energy and current of an electron beam in a linear accelerator, the linear accelerator powered by a radio frequency (RF) source generating an RF field characterized by a phase, the method comprising
coupling RF power into an accelerator section; and
modulating the RF power, coupled into the accelerator section, by post-generation modulation of the RF field.

2. A method according to claim 1, wherein post-generation modulation includes selective direction of the RF field on the basis of the phase of the field.

3. A method according to claim 2, further comprising dividing the RF field into components, wherein selective direction of the RF field is based on coherent addition of the components of the RF field.

4. A method according to claim 1, wherein the RF source is a magnetron.

5. A method according to claim 1, further comprising:
applying constant RF power to another accelerator section coupled with the accelerator section.

6. A method according to claim 5, wherein the another accelerator section is coupled in series with the accelerator section.

7. A method according to claim 5, wherein the another accelerator section is coupled in parallel with the accelerator section.

8. A method according to claim 1, further comprising:
applying modulated RF power to another accelerator section coupled with the accelerator section.

9. A method according to claim 8, wherein the another accelerator section is coupled in parallel with the accelerator section and applying the modulated RF power includes applying RF power modulated by post-generation modulation of the RF field based on coherent addition of the components of the RF field.

10. A method according to claim 8, wherein applying the modulated RF power includes switching the RF power on and off.

11. A method according to claim 3, wherein dividing the RF field into the components includes using a hybrid RF coupler.

12. A method according to claim 1, wherein the modulation of the at least one of energy and current of the electron beam includes the modulating at a rate from about 25 to 1,000 pulses per second.

13. A switch system for modulation of at least one of energy and current of an electron beam in a linear accelerator, the linear accelerators powered by a radio frequency (RF) source generating an RF field characterized by a phase, the switch system comprising:
an hybrid coupler for dividing the generated RF field into components; and
an RF phase-shifting section for receiving the components of the RF field from the hybrid coupler,
the switch system coherently adding the field components.

14. A switch system according to claim 13, wherein the RF phase-shifting section is configured to redirect the RF field components to the hybrid coupler.

15. A switch system according claim 13, wherein the RF phase-shifting section is configured to redirect the RF field components to another hybrid coupler of the switch system.

16. A switch system according to claim 13, wherein the RF phase-shifting section comprises at least one arm, the at least one arm having at least one fast switch and at least one phase changer, the at least one fast switch and the at least one phase changer disposed in mutually variable relationship.

17. A switch system according to claim 16, wherein the phase changer includes a plasma short

18. A switch system according to claim 16, wherein the modulation of at least one of energy and current of the electron beam in a linear accelerator includes the modulation at a rate from about 25 to about 1,000 pulses per second.

19. A switch system according to claim 16, wherein the at least one fast switch includes an electronically controlled plasma switch.

20. A linear accelerator comprising:
at least one accelerator section; and
a switch system for modulation of at least one of energy and current of an electron beam in a linear accelerator, the switch system including:
an hybrid coupler for dividing the generated RF field into components; and
an RF phase-shifting section for receiving the RF field components from the hybrid coupler,
the switch system for coherently adding the RF field components.

21. A linear accelerator according to claim 20, wherein the RF phase-shifting section comprises at least one arm, the at least one arm having at least one fast switch and at least one phase changer, the at least one fast switch and the at least one phase changer disposed in mutually variable relationship.

22. A linear accelerator according to claim 20, wherein the modulation of at least one of energy and current of the electron beam in a linear accelerator includes the modulation at a rate from about 25 to about 1,000 pulses per second.

23. A linear accelerator according to claim 20, wherein the RF phase-shifting section is configured to redirect the RF field components to the hybrid coupler.

24. A linear accelerator according to claim 20, wherein the RF phase-shifting section is configured to redirect the RF field components to another hybrid coupler of the switch system.

25. An inspection system for inspecting an object using penetrating radiation, the inspection system comprising
a linear accelerator according to claim 20 for generating penetrating radiation; and
a detector for detecting the penetrating radiation after interaction with the object.

26. An inspection system in accordance with claim 25, wherein the RF phase-shifting section comprises at least one arm, the at least one arm having at least one fast switch and at least one phase changer, the at least one fast switch and the at least one phase changer disposed in mutually variable relationship.
